(19) United States
(12) Patent Application Publication
(10) Pub. No.: US 2020/0286018 A1
(43) Pub. Date: Sep. 10, 2020

(54) REVERSE CHATBOTS

(71) Applicant: AMARIS.AI PTE. LTD., Singapore (SG)

(72) Inventors: Khue Hiang CHAN, Singapore (SG); Chien Siang YU, Singapore (SG)

(21) Appl. No.: 16/794,257

(22) Filed: Feb. 19, 2020

Related U.S. Application Data
(60) Provisional application No. 62/808,265, filed on Feb. 20, 2019.

(51) Int. Cl. G06Q 10/06; H04L 12/58

(52) U.S. Cl. CPC G06Q 10/06311; H04L 51/02

(57) ABSTRACT

A system and method for AI reverse chatbots with an enhanced pro-active initiative configured to provide supervision catering to personnel training and critical operation monitoring to ensure safety and security compliance. The reverse chatbots are configured to utilize sensory devices to track a user during a job. The job includes performing a series of actions and tracking of the user includes processing of sensory data to identify at least one incorrect action. The AI reverse chatbots are also configured to provide feedback to the user. Through real-time monitoring and feedback to avoid incorrect completion of the job, the reverse chatbots are configured to provide interactive supervision of the user.

### CROSS-REFERENCE TO RELATED APPLICATION

This application claims the benefit of U.S. Provisional Application No. 62/808,265, filed on Feb. 20, 2019, which is incorporated herein by reference in its entirety for all purposes.

### FIELD OF THE INVENTION

The present disclosure relates to Artificial Intelligence (AI) conversation stimulator systems, also known as chatbots. In particular, the present disclosure relates to AI reverse chatbots with an enhanced pro-active initiative configured to provide supervision catering to personnel training and critical operation monitoring to ensure safety and security compliance.

### BACKGROUND

Currently, the majority of tasks in our working society are still human-oriented and prone to human error. While certain mistakes may cost companies or entities momentary losses, some mistakes may potentially place human lives at risk. Extra measures, such as setting up a workflow with standard operational procedures (SOPs) or regulations, have been used to minimize human error. However, even as guidelines are provided, supervision is still mandatory to ensure strict compliance. Yet because current supervision is performed largely by a human supervisor or manager, it is not uncommon for a breach in regulations or procedures to occur.

As solutions are gearing towards developing AI systems for performing intellectual tasks, more focus is directed towards building interactive AI systems with enhanced intellectual or cognitive abilities. For example, an AI conversation stimulator system, also known as a chatbot, is designed to emulate a human dialog partner. A typical process of implementing a chatbot to conduct a conversation with a user involves two principal tasks: a) understanding the user's intent; and b) producing the correct answer. The chatbot simply scans keywords within a user input to identify a response from a database. For example, identifying keywords in the user input and searching in the database for pre-defined or machine-learned answers before presenting answers corresponding to the keywords. As for a more sophisticated chatbot, a natural language processing (NLP) system may be implemented to conduct a meaningful conversation.

However, conventional chatbots are merely a custodian of information, designed to provide users with answers. Such chatbots are typically deployed for customer service or information acquisition. Chatbots are not suitable for higher-level intellectual tasks, such as supervision.

Therefore, from the foregoing discussion, there is a desire to provide an AI system with an enhanced pro-active initiative capable of providing supervision catering to personnel training and critical operation monitoring to ensure safety and security compliance.

### SUMMARY

Embodiments generally relate to AI chatbot systems, such as reverse chatbots with an enhanced pro-active initiative configured to provide supervision catering to personnel training and critical operation monitoring to ensure safety and security compliance.

In one embodiment, a method for performing automated interactive supervision of a user includes providing backend components for tracking the user during a job, the job includes performing a series of actions. The tracking includes receiving and processing of sensory data from at least one sensory device to identify at least one incorrect action. The method further includes providing feedback to the user during the job, assigning a user profile type to the user based on updated user records stored in a storage medium of the platform. The updated user records include user's previous jobs activities. The platform is configured to provide interactive supervision through real-time monitoring and feedback to avoid incorrect completion of the job.

In another embodiment, a system for interactive supervision of a user includes a tracking module managed by backend components to track the user during a job. The job includes performing a series of actions and tracking a user includes receiving and processing of sensory data from at least one sensory device to identify at least one incorrect action. The system further includes a feedback module configured to provide feedback to the user during the job, a storage module for storing user records including the sensory data, previous jobs activities and user profile types of the user. The system is configured to provide interactive supervision through real-time tracking and feedback to avoid incorrect completion of the job.

In yet another embodiment, a method for providing interactive supervision includes receiving sensory data from at least one sensory device, tracking a user during a job. The job includes performing a series of actions and the tracking includes processing of received sensory data to identify at least one incorrect action. The method further includes providing feedback to the user and the feedback includes a list of questions configured to guide the user to correct the identified at least one incorrect action. The method also includes assigning a user profile type to the user based on updated user records stored in a storage medium of the platform and the updated user records include user's previous jobs activities. The method is configured to provide interactive supervision through real-time monitoring and feedback to avoid incorrect completion of the job.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of various embodiments. In the following description, various embodiments of the present disclosure are described with reference to the following, in which:

FIG. 1a shows an overview of an exemplary embodiment of a system architecture of an AI reverse chatbot system;

FIG. 1b shows an exemplary embodiment of an AI reverse chatbot system in collaboration with a field operator user;

FIGS. 2a-b show various exemplary processes of an embodiment of the AI reverse chatbot system;

FIGS. 3a-b show various exemplary processes of an embodiment of the AI reverse chatbot system; and

FIG. 4 shows an exemplary process of an embodiment of the AI reverse chatbot system.

### DETAILED DESCRIPTION

Embodiments described herein generally relate to AI systems. In particular, the AI system includes reverse chatbots with an enhanced pro-active initiative configured to provide supervision catering to personnel training and critical operation monitoring to ensure safety and security compliance.

As discussed, human operators are inherently unreliable and error-prone, mainly because it is impossible to maintain the same level of function or performance over an extended period of time and in varying ambient conditions. In less critical roles, such mistakes may cost companies or entities unnecessary momentary losses. For example, costly mistakes arising from failure to comply with current policies and laws involving tax, insurance, customs or cargo/freight agents. In critical roles, human error can lead to failures with catastrophic consequences and even threatening health and lives. For example, critical roles may include those involving technicians or engineers, medical practitioners and law enforcers. Furthermore, the occurrence of human error typically increases as the complexity of tasks increases. As such, Artificial Intelligence (AI) systems pose as an ideal solution to minimize human error as the systems can be programmed to execute tasks consistently and faultlessly, regardless of the complexity level of the tasks.

In one embodiment, an AI empowered reverse chatbot system is provided. The reverse chatbot system is configured to manage the performance of operational activities or jobs performed by operators or users in a safer, more compliant and transparent manner. An operator or user, for example, may refer to anyone who is performing a job or task. A job may be any kind of job. A job may include one or more procedures or actions to be performed by an operator. All procedures or events in a job has to be fulfilled before the job is considered as a completed job. For example, all events in a job can be listed in a form or a set of SOPs. For example, if a job is to prepare for surgery, then events of the job may include events necessary to prepare for the surgery. For example, the events may include making a list of required surgical tools, assembling together the required surgical tools, and ensuring proper sterilization of the required surgical tools. An event includes at least one action performed by the user as he or she fulfills the event. For example, if an event is to assemble together all required surgical tools, actions of the event include searching for the required surgical tools and putting all the required surgical tools in a temporary storage location. Depending on the complexity of an event, actions of an event may or may not be listed as a subset under a particular event in the set of SOPs.

Unlike conventional chatbots which are merely a custodian of information and designed to provide users with answers, the reverse chatbot system is configured to provide operational monitoring while implementing a 2-way communication with operators via external client devices. Additionally, the system may interact with external sensor devices to collect users' information, such as locations, positions and motion data of users.

As a result, the system allows remote real-time tracking and validating the quality and safety of a job to be performed, as well as alerting the user to any event which has deviated from standard regulations or may have compromised safety considerations. This also facilitates immediate correction of the user's actions associated with the deviated or compromised event, and thus avoid potential mistakes.

The AI system, for example, may conduct real-time tracking of users in a backend processing manner to minimize intrusions or interferences. Based on a user's information received from the external client device and/or external sensor devices, the backend AI system automatically infers the current status of the particular user. For example, the AI system identifies the user's job and a current event that the user is attempting to perform, as well as evaluates whether actions of the user are in compliance or safe.

When the AI system has detected deviations or compromised safety issues, the system will switch to alerting the user of the deviation and to performing the necessary measures to correct the user's actions associated with a deviated or compromised event.

In one embodiment, the reverse chatbot system utilizes checkpoints to enforce a user's compliance to pre-defined sets of standard operating procedures (SOPs). The AI system is configured to prompt the user for confirmative feedback and evidence that procedures in the predefined SOPs have been followed and guide them to rectify non-compliance actions or identify operational issues caused by other factors, for example, faulty equipment.

The user's information, such as a location, a position, motion data, and actions, during a job or task, may be collected and stored in a suitable storage media for retrieval when necessary. In addition, the system may prompt a user for evidence to validate the correctness of work performed upon completion of a job or task. The reverse chatbot system works as a single streamlined process that utilizes a series of integrated AI systems to track critical work tasks done instead of having a human supervisor. This process not only reduces work errors but also offers a high level of assurance by leveraging off robot-human collaboration, with the robot doing very tight workflow monitoring that has zero tolerance for flexibility due to compliance, security and safety reasons.

In one embodiment, the reverse chatbot system is configured to manage on-the-job training to encourage a more dedicated and conscientious working attitude from users. After detecting potential risky situations, the system is able to guide the users, for example using questions and answers, to understand why and how it is failing compliance or safety regulations in a particular event of a job. In addition, the tight monitoring by the system also discourages negligence, deliberate bypassing, or careless behaviors from users. On the other hand, users, for example, good performers, who are doing their jobs carefully and with high dedication will be recognized by the AI system. The AI system can differentiate users who are sub-par performers from those who are good performers and provide additional training for the sub-par performers by changing their attitudes and equip them with the skills needed to do careful work. In time, this serves to improve an overall group performance of a team which may be beneficial for a company or entity, for example through reflected increased profits.

Additionally, the AI system may retrieve all information of a particular user, including all actions and events associated with various jobs completed by the user so far. Based on the information, the AI system is able to associate the user's behavior to a profile type, for example, a careless user, a dedicated user or other profile types. This allows for potentially risky behaviors to be readily detected and avoided.

The operational architecture of a reverse chatbot system is based on distributed AI operations. The operational architecture of the system allows execution on numerous diverse environments, including different cloud environments, such as on-premise or hybrid with public clouds.

A core AI operational system integrates edge AI devices so that all AI-driven processes, including monitoring of a particular user, detection of risky situations, providing guidance for error avoidance and on-the-job training, as well as collecting evidence for validating of a completed job and keeping a job log including all evidence and actions associated with the job, are carried out in a single streamlined process. This process not only reduces work errors but also offers a high level of assurance by leveraging off AI-human collaboration, with the robot doing very tight workflow monitoring that has zero tolerance for flexibility due to compliance, security and safety reasons.

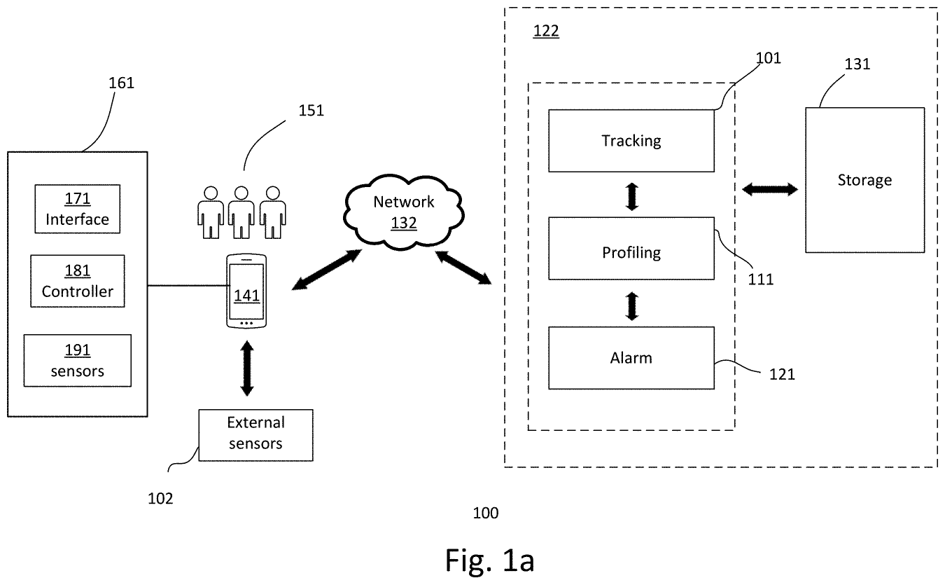

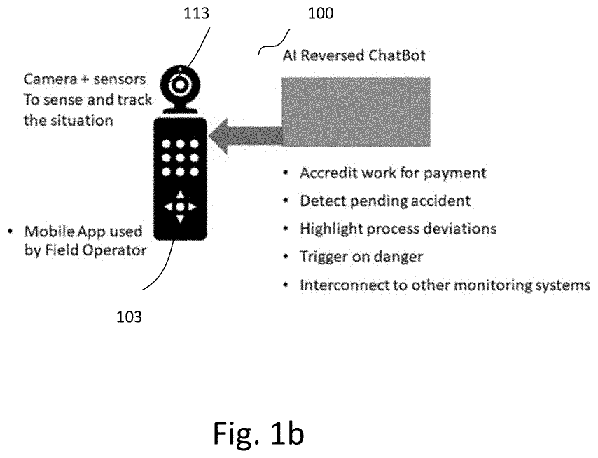

FIG. 1a shows an overview of an embodiment of a system architecture of an AI reverse chatbot system 100. The system 100 may include one or more components, including modules or layers. The various components may be implemented using software and/or hardware, which may optionally be across multiple locations and/or using multiple devices or units. The system 100, for example, may be implemented as a single system, multiple systems, distributed systems, or in any other form.

In one embodiment, the system 100 includes a tracking module 101, a profiling module 111, an alarm module 121 and a storage module 131 which are communicatively coupled to one another. Frontend and backend components may be utilized to run the modules. For example, the frontend components are used to run the system on a client device 141. Although only one client device is shown, it is understood that the system may include numerous client devices which communicate with the reverse chatbot system. The client device 141 illustrated in FIG. 1a is a representative of a large number of client devices that can be included in the system 100.

The client device 141 may be a mobile processing device with a memory and processor. In addition, the client device may include a speaker, a microphone and a display for facilitating communication between the system and an operator or end-user (user) 151, sensing components, such as a global positioning system (GPS), cameras, motion detection for determining movements, such as the number of steps taken and distance traveled, as well as other sensing components. Providing other features for the client device may also be useful. For example, features that facilitate the monitoring of a user by the system. The features of a device may depend on the jobs which are monitored by the reverse chatbot system. The client device may be a dedicated client device specifically designed for the reverse chatbot system. Alternatively, the client device may be a general-purpose device, such as a smartphone or a tablet computer. Other types of mobile devices may also be useful to serve as a client device.

A client device 141 may be associated with a user 151 of the system 100. For example, a user 151 interacts (or interfaces) with the system 100 using the client device 141 associated with the particular user. It is understood that the system may be configured to monitor any number of users 151.

In practice, a user 151 may download a frontend system 161 to a client device 141 associated with the particular user 151 as a computer application (App). For example, the frontend system (or App) 161 resides on the client device 141. The App may include software components in the form of computer-executable program instructions for implementing or running the App on the client device 141. The computer-executable program instructions may further specify a unique name for the user. The App is configured to communicate with the reverse chatbot system. Once installed, the App runs on the client device. For example, when the user is working, the user activates the App on the client device.

In one embodiment, the frontend system is a mobile application. The App, for example, may be a native mobile application downloaded from an online App store or marketplace and directly installed onto the client device 141. In an alternative implementation, the frontend system may be a web-based application (web App). A web App is, for example, an Internet-enabled App that is accessed through the client device's web browser. Other configurations of the App may also be useful.

The App 161 is able to interface with the client device 141's resources, such as native features, information and hardware. In one embodiment, the App 161 includes a controller module 181 and an interface module 171. For example, the controller module 181 may control interface between various modules of the App 161 and the client device 141's resources, including a camera, a microphone, a speaker and sensors 191. In addition, the controller module also controls external devices 102 including wearable sensors or independent sensors such as surveillance cameras. A module, for example, may be a programming (e.g., software) module executed by computing systems (e.g., processors) that are part of the system 100, including a client device 141 and a server computer. The App may also include other modules such as a media player module for presenting information relayed by the system to the client devices for viewing by the users.

In one embodiment, when the App is running on the client device 141, the interface module 171 may display the App as a full-screen application and provide access to the information and functionalities implemented in the system 100. The interface module 171 may present information output for display on the screen of the client device 141, which allows the user 151 to navigate the system 100 and to interact with the components, modules, layers or digital content therein. For example, the interface module 171 allows a user 151 and the system to communicate, such as to co-provide feedback when prompted by the system.

In one embodiment, the interface module 171 may include a touch-based interface. For example, the interface module 171 allows a user 151 to navigate and interact with the system 100, including the frontend and backend systems 161 and 122, by touching native interface elements (e.g., pictures or text) presented on the screen of the client device 141. In alternative implementations, the interface module 171 may present a graphical user interface. For example, a graphical user interface enables the user to navigate and interact with the system 100 through the use of peripheral input devices (e.g., keyboard, mouse, etc.). Providing other types of interface modules 171 may also be useful.

In one embodiment, a backend system 122 may be configured to run various modules of the system, for example, a tracking module 101, a profiling module 111, and a alarm module 121. The backend system further includes a storage module 131 for storage of information. The backend system 122 may be implemented on one or more server computers. A server computer may represent multiple computing devices in communication with each other to perform the actions of a server computer (e.g., cloud computing). Alternatively, the server computer may be implemented on a single computing device.

A server computer may include a processor (e.g., CPU) and memory (e.g., RAM, ROM, etc.), and one or more storage devices storing data structures and/or computer instructions for execution by the processor. For example, a server computer can include one or more computer-readable data stores to facilitate managing App requests from the client device 141. Various types of computers may be employed for the server. For example, the computer may be a mainframe, a workstation, as well as other types of processing devices. The memory may include digital data that can be accessed by the processor. The server computer and/or data store may be coupled with various databases or storage devices in the form of any suitable computer-readable medium, such as a hard disc drive, a memory device, a flash drive or an optical drive.

In some implementations, the systems and computing devices described herein (e.g., client devices, server computers) are communicably connected to each other by a network 132. The network 132 may include, for example, one or more communication networks of any suitable type in any combination, including wireless networks (e.g., WI-FI network), wired networks (e.g., Ethernet network), local area networks (LAN), wide area networks (WAN), personal area networks (PAN), mobile radio communication networks, the Internet, and the like. Further, the network 132 may include one or more network topologies, including a bus network, a star network, a ring network, a mesh network, a star-bus network, a hierarchical network, and the like. It should be appreciated that the server computer may also be in communication with other remote servers or various client devices through other networks or communication means.

Communications between the client device 141 and server computer may be facilitated through various communication protocols, including data transmission media communications devices, Transmission Control Protocol (TCP), Internet Protocol (IP), File Transfer Protocol (FTP), Hypertext Transfer Protocol (HTTP), Hypertext Transfer Protocol Secure (HTTPS), Session Initiation Protocol (SIP), Real-Time Transport Protocol (RTP), Global System for Mobile Communications (GSM) technologies, Code Division Multiple Access (CDMA) technologies, Short Message Service (SMS), Long Term Evolution (LTE) technologies, wireless communication technologies, in-band and out-of-band signaling technologies, and other suitable communication networks and technologies.

In some embodiments, the system 100 includes one or more communication interfaces (not shown) to facilitate communications between the frontend system 161 and backend system 122 using the various communication protocols. A communication interface may include hardware and/or software. In one implementation, the communication interface may include digital signal processing circuitry to provide one or more interfaces for communication (e.g., packet-based communication) between computing devices or networks. For example, a communication interface may include a network interface controller (NIC) or network adapter for communicating with an Ethernet or other wire-based network or a wireless NIC (WNIC) or wireless adapter for communicating with a wireless network, such as a WI-FI.

Alternatively, backend components of the system may also run on the client device and include managing the client device 141's resources, including a camera, a microphone, a speaker and internal sensors. Other than the client device, backend components can also run on external devices such as sensors, cameras or Internet of Things (IoT), etc. IoT may include robots with a camera or even equipment associated with a job. AI backend components process input data from client devices and external devices. The input data may include, for example, sensory data from client devices, IoT remote sensing data, etc.

The tracking module 101 of the system 100 monitors a user 151 throughout his course of completing a job. A job, in this case, includes one or more procedures or events to be performed by an operator or user. A user can be a paid employee or an individual assigned to a job or task. For example, a nurse may be assigned to a job of preparing for surgery or administering a medicine dosage to a patient. Other types of users may also be useful.

The tracking module utilizes received sensory information from client devices 141 and IoT for AI backend processing. The sensory information may include the user's information such as a location, a position and motion data. The AI processed information validates a current situation of the user, as well as analyzes the user's actions for any non-compliance or dangerous actions. Through backend processing, supervision can be achieved silently and non-intrusively so that the user can focus on the job at hand with minimal interference.

The profiling module 111 is configured to identify a user profile of a user 151. Based on historical job records of the user, the profiling unit analyzes a user's conduct in previous jobs and assigns a profile type to the user. For example, a user who makes frequent obvious mistakes is categorized as a careless user. A user who follows SOPs closely and rarely makes mistakes is categorized as a careful user. Based on an assigned user profile, the system can quickly infer if user's actions have a high chance of leading to a risky or non-compliance outcome so that mistakes can be timely avoided.

During a user's execution of a job, the profiling module determines a current state of the user to ensure the user is at an optimal condition to perform safely. For example, whether the user is alert, responsive, or attentive. In addition, the profiling module also recognizes best performers, for example, users who are always doing their jobs carefully and compliantly, from other users, and the system will retrain the other users to improve their overall performance. This creates a system of incentives and deterrence as good performance is recognized and potentially risky behaviors from careless users are detected quickly and avoided.

Once any deviation, non-compliance, or dangerous action is detected by the system, the alarm module relays the information to the client device of the user via the frontend components. For example, a notification or reminder is sent for display on the interface of the client device. The alarm module 121 is also configured to request feedback from the user. A request can be in the form of a list of questions or a checklist. The questions may serve to guide the user to provide answers which direct the users to correct the deviated or non-compliant actions. Questions directed to educating the users may also be included and may serve as part of on-the-job training. Questions or a checklist can also require the user to provide evidence that a job is done correctly.

A user's information, including sensory information such as motion data, actions, user's locations, user profiles, user's feedback, for all jobs done by the user is recorded and stored in the storage module 131 of the system. The information may later serve as evidence to affirm a correct job done.

The present system, in one embodiment, forms an integrated distribution of AI systems. The system streamlines roles of a supervisor into a single process through the use of AI frontend and backend components to coordinate running of the various modules, client devices and IoT for AI-human collaboration. In this way, the system functions like a human supervisor, but without inconsistency and errors, and therefore offers a high level of assurance with the AI performing very tight workflow monitoring and not tolerating flexibility due to compliance, security and safety reasons.

For an individual, the system is advantageous to ensure safety of a user. As for businesses, the main benefits include reduced direct costs, for example arising from replacement of first-line supervisors and reporting officers by the reverse chatbots, and also enhanced performance metrics arising from a reduction in staff faults and errors. Reduced direct costs lead to increased profits. Furthermore, the businesses will benefit from the added customer and client satisfaction gained by the assurance that business operations are carried out in a safer, more compliant and transparent manner.

The AI reverse chatbot system takes on the role of a cautious background supervisor, who is enforcing safety and following the correct procedures with a matched understanding of the situation. The system exploits an extensive methodology to generate an optimal question list for the user, conducted with the knowledge of their background and history of common, known and predictable mistakes. In a complete analogy to the human driver in an autonomous vehicle complementing the AI system to ensure the appropriate level of operational safety and compliance, here the AI system complements the human cognitive faculties to rectify their inherent deficiencies and ensure a reliable and consistent level of task executions. It is expected that, as long as the systems of AI are not fully perfected and operating flawlessly, the current interim period in which human operators coexist with AI will require the supervision and expertise of AI (and vice versa), in a gradual shift towards autonomy whereby AI systems gain more and more control.

FIG. 1b shows an exemplary embodiment of an AI reverse chatbot system 100 in collaboration with a field operator user. In one embodiment, the system may be run on a remote client device 103 via frontend components in the form of a frontend system. As illustrated, a field operator user operating in a remote site may access the chatbot system by downloading a frontend system to a client device associated with the field operator user as a mobile application (App). As discussed, other configurations of the App may also be useful. For example, the frontend component can also be a computer application or a web-based application.

The App may include software components in the form of computer-executable program instructions (computer instructions) for implementing or running the App on the client device 103. The App is installed and displayed at the client device 103.

As discussed, the App is able to interface with the client device 103's resources, such as native features, information and hardware. In one embodiment, the App includes a controller module and an interface module. For example, the controller module may control interface between various modules of the App and the client device 103's resources, including a camera 113, a microphone, a speaker and sensors. In addition, the controller module may also control external devices associated with the client device. The external devices may include wearable sensors or independent sensors such as surveillance cameras. The App may also include other modules such as a media player module for presenting information relayed by the system to the client devices for viewing by the users.

The interface module of the App presents information output for display on the screen of the client device 103, which allows the user to navigate the system 100 and interact with the components, modules, layers or digital content therein. For example, the interface module allows a user to provide feedback when prompted by the system.

Various backend components of the reverse chatbot system may run in the background to facilitate the supervising of a user's situation. Supervising includes managing mobile resources to receive sensory information, detecting possible or pending accidents, danger, or process deviation from a set of SOPs and highlighting detected issues to the user.

As information collected from the user's client device may be limited, in one embodiment, the reverse chatbot system may also be communicatively coupled to other external devices, such as IoT, to collect additional information of the user's surroundings. Further, the additional information may be used for validating the received mobile data. In one embodiment, other external devices facilitate as a resource pool or network for the AI system to access knowledge or contact key persons, such as a manufacturer, a service provider, relevant to a job in progress, may be employed.

A system which can collaborate with a user at a remote site is useful to aid the user to finish a job more and not be hindered by limited resources outfield. For example, a field telecommunications technician who is assigned to perform a job inside a poorly lit manhole. An AI system may guide the technician by sending him information of local manhole site knowledge, validating the accuracy of the job process. Furthermore, the AI system may timely detect danger and send alert to relevant authorities for help. By avoiding potential mistakes and keeping a record of the entire work process, correct work done can be accredited immediately, and automatically be submitted for contract service payment. All these can be done without a human supervisor or a team to be physically around, thereby eliminating direct resources cost as well.

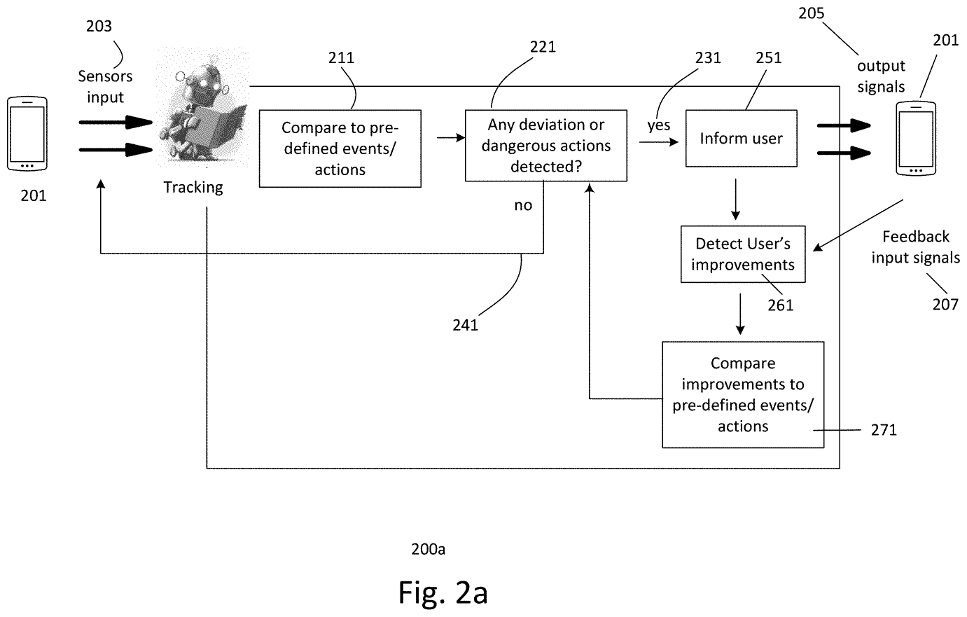

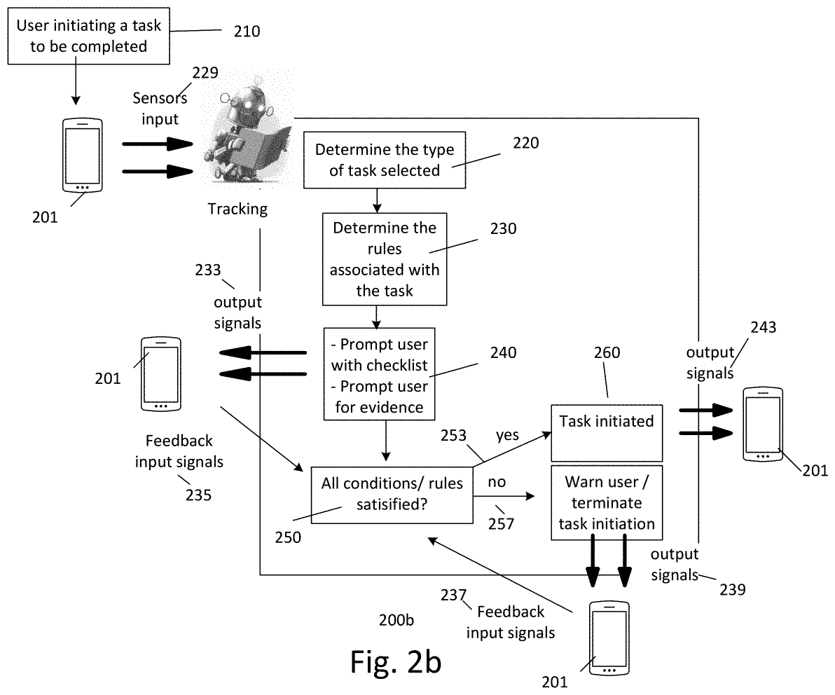

FIGS. 2a-b show various exemplary processes of an embodiment of the AI reverse chatbot system 200. The system includes a tracking module. The tracking module monitors a user throughout his course of completing a job. A user can be a paid employer or an individual. For example, a nurse user assigned to a job of preparing for surgery or a patient user administering a medicine dosage.

A job, in this case, includes one or more procedures or events to be performed by an operator or user. All procedures or events in a job has to be fulfilled before the job is considered as a completed job. For example, all events in a job can be listed in a form of a set of Standard Operating Procedures (SOPs). If a job is to prepare for surgery, then events of the job include events necessary to prepare for the surgery, for example, make a list of required surgical tools, assemble together all required surgical tools, ensuring proper sterilization of the required surgical tools, etc. An event includes at least one action performed by the user as he or she fulfills the event. For example, if an event is to assemble together all required surgical tools, actions of the event include searching for the required surgical tools and putting all the required surgical tools in a same temporary storage location.

FIG. 2a shows an exemplary monitoring process 200a of an embodiment of the AI reverse chatbot system. As shown in FIG. 2a, in one embodiment, the tracking module facilitates real-time monitoring of a user throughout a job. Information from external client devices 201 and/or external sensor devices is automatically processed by AI backend components to infer a present situation of the user. For example, the AI system identifies the user's job and a current event that the user is attempting to perform, as well as evaluates whether actions of the user are in compliance or safe. As the backend processing is conducted silently and non-intrusively in the background, the user is able to focus with minimal interferences unless the situation detects an issue.

Based on sensory information 203, the tracking module extracts relevant information of a user's actions corresponding to a current event and compares it to a set of predefined events or actions in 211. At 221, the AI detects if there is any deviation between the user's actions and the predefined events or actions.

The set of predefined events may include all events that have to be fulfilled in a job. An event can be a simple or a complex event. A simple event may include natural actions that a user will perform naturally without requiring further instructions. For example, a simple event of writing down a list of required surgical tools. The user will naturally take the appropriate stationery and fulfills the writing event. On the contrary, a complex event may include specialized actions that only a user who is experienced in fulfilling the particular complex event will be aware of. In such cases, the set of predefined events may include listing subsets of predefined actions corresponding to a particular event.

In one embodiment, at 221, the AI system may also infer from a user's user profile to predict if the user's actions are potentially dangerous or hazardous. For example, when a careless user is fulfilling a simple event of assembling together all required surgical tools, the AI system may predict a sharp injury risk as the careless user has a tendency of leaving the assembled tools in an open area. In such cases, the system monitors the actions of the user more closely to ensure compliance.

If no deviation or potential risk is detected at 241, the AI system returns to background monitoring. If AI system detects a deviation or potential risk at 231, frontend components of the system will take over to alert the user in 251 via the client device 201 and perform necessary measures to correct the user's actions.

Once the user receives the feedback, for example, sent as output signals 205, from the system to correct deviated or dangerous actions, the tracking module continues to check if the user has corrected the non-compliance or dangerous actions.

At 261, the system receives feedback 207 from the client device 201 on the user's actions and detects for improvements or changes in the user's actions. In 271, the system compares improved or changed actions against the set of pre-defined events or actions and returns back to 221 where the AI system detects if there is any deviation between the user's actions and the predefined events or actions.

If no other deviation or dangerous action is detected at 241, the system resumes back to background monitoring. However, if a deviation is detected at 231, the processes 251, 261, 271 and 221 will repeat until no deviation is detected. Alternatively, after a number of repeats, the system may decide to terminate the user's job progress by, for example shutting down user's operating equipment or notifying relevant authorities to step in.

In one embodiment, the measures to correct the user's actions may include a notification, a reminder, or a request for the user's feedback. For example, the request can be in the form of a list of questions or a checklist. The questions may serve to guide the user to provide answers which direct the user to correct deviated or dangerous actions. In some embodiments, the questions directed to educating the users may also be included and may serve as part of on-the-job training. Questions or a checklist may also require the user to provide evidence that a job is done correctly.

In one embodiment, questions may be used for users to demonstrate their knowledge and understanding of a job. For example, for jobs that may require training, testing and licensing such as driving, flying, operating a drone or using a firearm, the system serves to constantly monitor and validate a licensed user's learning certifications to ensure that the user is keeping up with changes in the relevant legislation.

In cases where the user fails to perform the corrected action after feedback from the system or when the system decides that the user's action is posing a dangerous safety hazard, the measures may also include terminating the user's job progress, for example, by shutting down the user's operating equipment and/or notifying relevant authorities to step in.

Other than performing passive monitoring, in an alternate embodiment, the tracking module may also facilitate checkpoint monitoring. The checkpoint monitoring functions like a logical login platform before a critical process can proceed. In one embodiment, the checkpoint monitoring can be initiated before the start of a job. Alternatively, it can be before the start of an event within a job-in-progress.

FIG. 2b shows an exemplary checkpoint monitoring process 200b of an embodiment of the AI reverse chatbot system. As seen in FIG. 2b, at 210, a user sends an input via the client device 201 to initiate for the system's permission to begin a job. The AI system processes sensory input data 229 to identify the job type in 220. At 230, the AI system retrieves relevant rules associated with the identified job type. Next, a list of questions or a checklist is generated and sent as output 233 to the user at 240. The list of questions or checklist serves to highlight items that the user would need to consider before the start of a job. For example, before initiating aircraft take-off, a cockpit staff is prompted by the system with a list of pre-flight instrumentation checks. Further, the system may also request for evidence that the user has performed the necessary actions in accordance with the questions or checklist, such as providing actual readings or records. This ensures that the user is actively performing a vigilant and conscientious role.

Once the system receives feedback 235 from the user, the system checks if all the questions or checklist have satisfactorily been complied with at 250. If satisfied at 253, the system will proceed to send output 243 to the client device 201. The job is initiated at 260. In cases where the system includes managing equipment associated with a job or event to be initiated, the system initiates a power start-up of the equipment so that the user can proceed.

If conditions are not satisfied in 257, the system sends a request for feedback 239 to the user via the client device 201. A request can be in the form of a list of questions. The questions may serve to guide the user to provide answers which direct the users to satisfy the list of questions or checklist for job initiation. Questions directed to educating the users may also be included and may serve as part of on-the-job training. Questions or a checklist can also require the user to provide evidence that the user has performed the necessary actions to comply with the questions or checklist.

The questions, in one embodiment, may request a user to demonstrate his or her knowledge and understanding of a job. For example, for jobs that may require training, testing and licensing such as driving, flying, operating a drone or using a firearm, the system serves to constantly monitor and validate a licensed user's learning certifications to ensure that the user is keeping up with changes in the relevant legislation. This ensures the user is validly licensed to execute a critical process that is tightly regulated.

At 250, the tracking module checks to determine if the user satisfies the conditions and rules based on the received user feedback 237. If the conditions and rules are satisfied, the user may initiate the job or task. If not, the system warns the user to terminate the job initiation process. In some cases, the system may provide an opportunity for the user to correct the non-compliance of the conditions or rules. The system may provide a threshold number of tries for the user to correct the non-compliance, after which, the system terminates the initiation process and informs the appropriate manager of the situation.

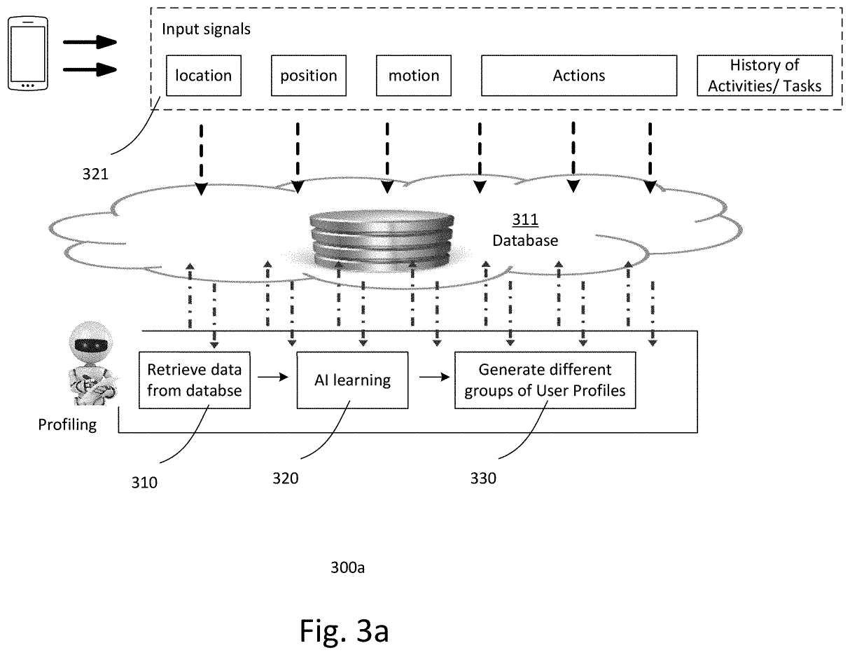

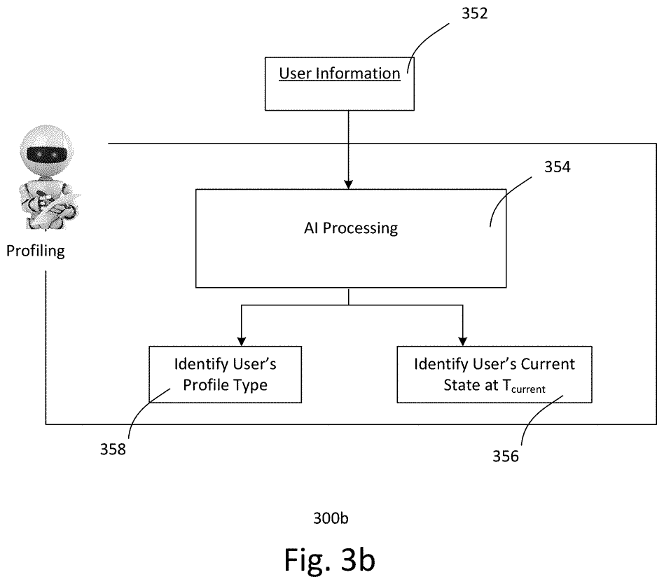

FIGS. 3a-b show various exemplary processes of an embodiment of the AI reverse chatbot system 300a. The system includes a profiling module. The profiling module is configured to determine a user profile. In one embodiment, various profile types are categorized by AI learning so that each profile type is distinct from one another by a unique set of characteristics or features. A profile type may include a careless type, a dedicated type, as well as other types. An example of an AI learning process may include determining a user profile by inputting features extracted from the information of a particular user and associating the user to a profile type having the most similar features as the particular user. A user profile may include a careless user, a dedicated user, or other user category types

Referring to FIG. 3a, the process 300a shows an example of using AI learning to generate various categories of profile types. At 310, the profiling module may retrieve data from a storage module of the system. The data 321 may include user's information such as motions, actions, user feedback, for example, answers and evidence, activity records of previous jobs. AI learning is used at 320 to generate various profile types with each having a unique set of characteristics or features in 330. The various profile types may later be used as a reference to assign a user profile to the user.

In one embodiment, the storage module of the system includes a database 311. The database is configured to store information received from client devices and external devices such as IoT. The information 321 may include users' information such as motions, actions, user feedback, for example, answers and evidence, activity records of previous jobs, etc.

Referring to FIG. 3b, it shows an exemplary profiling process 300b of the AI reverse chatbot system during a job execution process. At 352, the profiling module retrieves user's information.

In one embodiment, the user's information may include sensory information of a user at a current time T_{current}. T_{current} may be used by AI processing at 354 to determine a current state of the user at 356 to ensure the user is at an optimal condition to perform safely. For example, whether the user is alert, responsive, or attentive.

In another embodiment, AI processing at 354 extracts features or characteristics from the user's information. The user's information includes records of previous job activities. The features are used as input for AI learning to match the user to a most similar profile type having similar features. The user is thus assigned to a user profile corresponding to the matched profile type at 358. By utilizing AI learning and processing, the profiling module allows quick identification of a user's profile type at any time of a job-in-progress. Based on a user profile, during the monitoring of the user, the system can quickly infer if the user's tracked actions have a high chance of leading to a risky or non-compliance outcome. This allows timely avoidance of mistakes.

In addition, as AI learning is used, a user profile is always determined based on a most updated record of user's information including the most recent job activities. For example, a previous careless user, after several rounds of collaboration with the system during his job, may exhibit improved actions in the user's more recent jobs. Therefore, the AI systems will take into account user's improved recent changes, and during user's next job execution, the AI learning may assign the user a different user profile, for example, a less careless user.

Similarly, it is possible for a previous conscientious user who has become complacent, to receive several notifications and reminders from the system for lack of compliance in the user's more recent jobs. In such a case, the user's user profile may be updated to a careless user. This may also serve as a lesson for the user to be more conscientious to improve performance.

This creates a flexible system which is able to recognize that a user's performance may change over time and adjust its processing parameters to provide more accurate monitoring. Overall, the system forms a basic incentive and deterrence system where good performance is recognized and encouraged.

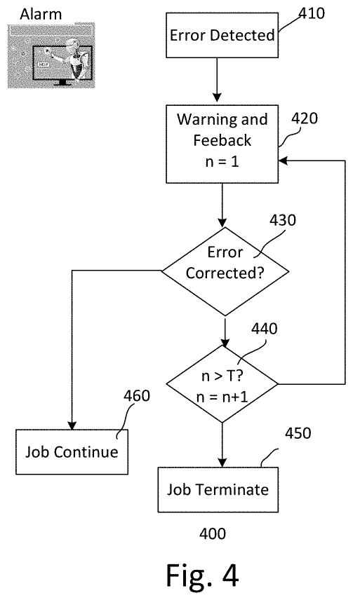

FIG. 4 shows an exemplary process 400 of an embodiment of the AI reverse chatbot system. The system includes an alarm module. Once the system detects an error at 410, such as a deviated, a non-compliant, or a dangerous action, the alarm module relays the information to the client device via frontend components at 420. For example, a warning notification or reminder is sent for display on the interface of the client device. The alarm module may also be configured to send a request for feedback to the user. A request can be in the form of a list of questions or a checklist. The threshold number n may be initialized to 1. The questions may serve to guide the user to provide answers which direct the users to correct the error, such as a deviated or a non-compliant action. Questions directed to educating the users may also be included and may serve as part of on-the-job training. Questions or a checklist can also require the user to provide evidence that a job is done correctly.

At 430, the system determines if the error is corrected or not. If the error is corrected, the system allows the user to continue with the job at 460. If the error is not corrected, the system proceeds to 440 to determine if n is greater than a threshold number T. The threshold number, for example, may be set at 3. Other values of T may also be useful. If n is greater than T, the system terminates the job by the user at 450. If n is not greater than T, the system returns to 420 and repeats until the error is corrected or until n is greater than T.

The inventive concept of the present disclosure may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method for performing automated interactive supervision of a user comprising:
providing backend components for tracking the user during a job, the job includes performing a series of actions, wherein the tracking includes receiving and processing of sensory data from at least one sensory device to identify at least one incorrect action;
providing feedback to the user during the job;
assigning a user profile type to the user based on updated user records stored in a storage medium of the platform, wherein the updated user records include user's previous jobs activities; and
wherein the platform is configured to provide interactive supervision through real-time monitoring and feedback to avoid incorrect completion of the job.

2. The method of claim 1 wherein the job includes one or more events and the series of actions are performed to complete the one or more events.

3. The method of claim 2 wherein the at least one incorrect action is a deviated action, wherein the deviated action leads to an event not compliant with one of a plurality of pre-defined events configured to ensure smooth operations and safety of the user.

4. The method of claim 3 wherein the tracking further comprises using an AI processing feedback loop to identify the at least one incorrect action, wherein the AI processing feedback loop includes
analyzing user actions performed to complete one event in the job, and
determining if the user actions will lead to completing of an event that is compliant with one of the plurality of predefined events.

5. The method of claim 3 wherein a form of the feedback includes a request for user feedback, wherein the request for user feedback includes either one or a combination of the following
a list of questions,
a checklist,
evidence that one or more events in a job are performed in compliance with corresponding predefined events, and
wherein the user feedback is stored with the sensory data as user records in the storage medium.

6. The method of claim 5 wherein the feedback to the user is configured to:
guide the user to correct the at least one identified incorrect action during the job;
train the user to improve a user performance during the job; and
validate learning certifications of the user.

7. The method of claim 5 wherein the feedback to the user is configured to facilitate as part of a logical login process before the user can proceed to start a job or an event.

8. The method of claim 1 wherein assigning the user profile to the user includes extracting features from the updated user records and using AI learning techniques to match the user to a profile type sharing same features as the user.

9. The method of claim 8 wherein the platform is configured to provide interactive supervision through real-time tracking and feedback by:
identifying a current state of the user based on the sensory data;
determining whether an incorrect action will be performed based on the identified current state and assigned user profile; and
providing feedback to the user before the incorrect action is performed in order to avoid incorrect completion of the job.

10. A system for interactive supervision of a user comprising:
a tracking module managed by backend components to track the user during a job, the job includes performing a series of actions, wherein tracking a user includes receiving and processing of sensory data from at least one sensory device to identify at least one incorrect action;
a feedback module configured to provide feedback to the user during the job;
a storage module for storing user records including the sensory data, previous jobs activities and user profile types of the user; and
wherein the system is configured to provide interactive supervision through real-time tracking and feedback to avoid incorrect completion of the job.

11. The system of claim 10 wherein the job includes one or more events and the series of actions are performed to complete the one or more events.

12. The system of claim 11 wherein the at least one incorrect action is a deviated action, wherein the deviated action leads to an event not compliant with one of a plurality of pre-defined events configured to ensure smooth operations and safety of the user.

13. The system of claim 12 wherein the tracking further comprises using an AI processing feedback loop to identify the at least one incorrect action, wherein the AI processing feedback loop includes
analyzing user actions performed to complete one event in the job, and
determining if the user actions will lead to completing of an event that is compliant with one of the plurality of predefined events.

14. The system of claim 12 wherein a form of the feedback includes a request for user feedback, wherein the request for user feedback includes either one or a combination of the following
a list of questions,
a checklist,
evidence that one or more events in a job are performed in compliance with corresponding predefined events, and
wherein the user feedback is stored as user records in the storage module.

15. The system of claim 14 wherein the feedback to the user is configured to:
guide the user to correct the at least one identified incorrect action during the job;
train the user to improve a user performance during the job; and
validate learning certifications of the user.

16. The system of claim 14 wherein the feedback to the user is configured to facilitate as part of a logical login process before the user can proceed to start a job or an event.

17. The system of claim 10 further comprising a profiling module configured to assign a user profile type to the user based on updated user records stored in the storage module.

18. The system of claim 17 wherein the profiling module is configured to assign the user profile type to the user by first extracting features from the updated user records and using AI learning techniques to match the user to a profile type sharing same features as the user.

19. The system of claim 18 wherein the system is configured to provide interactive supervision through real-time tracking and feedback by:
identifying a current state of the user based on the sensory data;
determining whether an incorrect action will be performed based on the identified current state and assigned user profile; and
providing feedback to the user before the incorrect action is performed in order to avoid incorrect completion of the job.

20. A method for providing interactive supervision comprising:
receiving sensory data from at least one sensory device;
tracking a user during a job, the job includes performing a series of actions, wherein the tracking includes processing of received sensory data to identify at least one incorrect action;
providing feedback to the user, wherein the feedback includes a list of questions configured to guide the user to correct the identified at least one incorrect action;
assigning a user profile type to the user based on updated user records stored in a storage medium of the platform, wherein the updated user records include user's previous jobs activities; and
wherein the method is configured to provide interactive supervision through real-time monitoring and feedback to avoid incorrect completion of the job.
